(19) United States
(12) Patent Application Publication
(10) Pub. No.: US 2025/0129193 A1
(43) Pub. Date: Apr. 24, 2025

(54) CYCLIC OLEFIN-BASED COPOLYMER, CYCLIC OLEFIN-BASED COPOLYMER COMPOSITION, VARNISH, CROSSLINKED BODY, FILM OR SHEET, LAYERED PRODUCT, CIRCUIT BOARD, ELECTRONIC DEVICE, AND PREPREG

(71) Applicant: MITSUI CHEMICALS, INC., Chuo-ku, Tokyo (JP)

(72) Inventors: Manami UENO, Sodegaura-shi, Chiba (JP); Hirohiko MURASE, Kuga-gun, Yamaguchi (JP); Fumito TAKEUCHI, Sodegaura-shi, Chiba (JP)

(73) Assignee: MITSUI CHEMICALS, INC., Chuo-ku, Tokyo (JP)

(21) Appl. No.: 18/835,640

(22) PCT Filed: Feb. 1, 2023
(86) PCT No.: PCT/JP2023/003179

§ 371 Date: Aug. 2, 2024

(30) Foreign Application Priority Data
Feb. 4, 2022 (JP) 2022-016604

(51) Int. Cl. C08F 236/20; C08F 232/08; C08J 5/24; C08J 7/04; C09D 7/20; C09D 145/02

(52) U.S. Cl. CPC C08F 236/20; C08F 232/08; C08J 5/24; C08J 7/0427; C09D 7/20; C09D 145/02; C08J 2345/02

(57) ABSTRACT

A cyclic olefin-based copolymer including: (A) structural units (A) derived from one or more olefins represented by General Formula (I), (B) structural units (B) derived from one or more cyclic non-conjugated dienes represented by General Formula (II), and (C) structural units (C) derived from one or more cyclic olefins represented by General Formula (III).

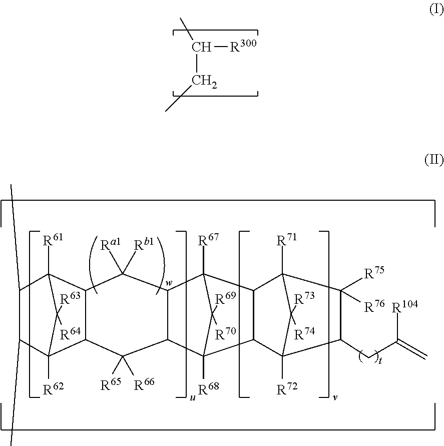

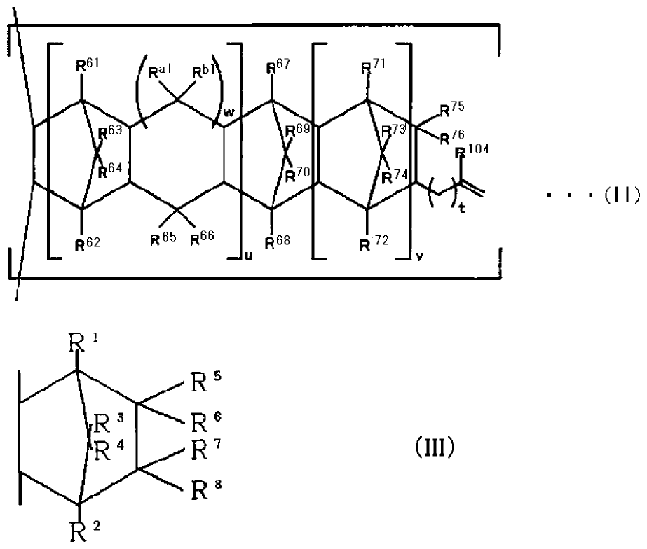

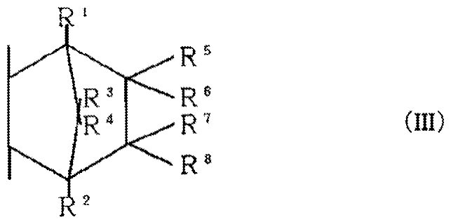

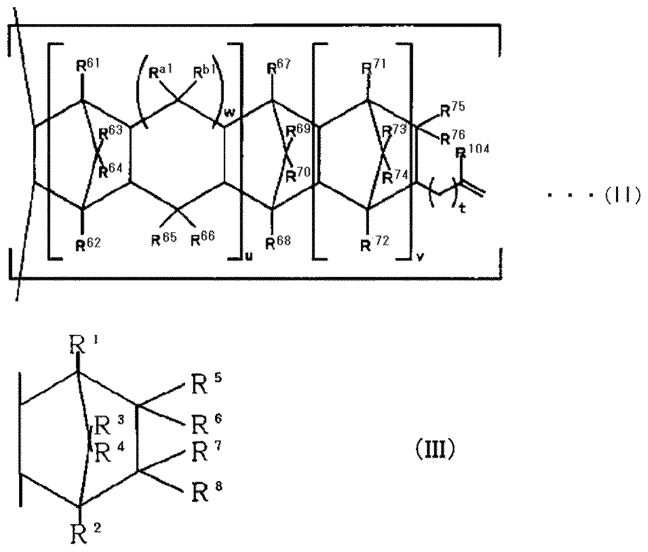

### TECHNICAL FIELD

The present invention relates to a cyclic olefin-based copolymer, a cyclic olefin-based copolymer composition, a varnish, a crosslinked body, a film or sheet, a layered product, a circuit board, an electronic device, and a prepreg.

### BACKGROUND ART

In recent years, in addition to an increase in wireless communication devices and the like using high-frequency bands, an increase in the communication speed has inevitably led to high-frequency bands being widely used. Along with this, there has been a demand for materials for circuit boards having high insulating properties and a small dielectric loss tangent to reduce a transmission loss at high frequencies as much as possible.

Resin materials used for such circuit boards include, for example, the cyclic olefin copolymers obtained by copolymerizing dienes, described in Patent Document 1 or Patent Document 2.

Patent Document 1 and Patent Document 2 disclose that a sheet obtained by crosslinking cyclic olefin-based copolymers obtained by copolymerizing a specific diene compound with an organic peroxide or the like exhibits excellent dielectric characteristics.

In addition, Patent Document 3 or Patent Document 4 discloses a crosslinkable resin molded body containing a crosslinkable cycloolefin polymer, in which the crosslinkable resin molded body is excellent in fluidity and solvent solubility during heating.

### RELATED DOCUMENT

### Patent Document

[Patent Document 1] Japanese Unexamined Patent Publication No. 2010-100843

[Patent Document 2] International Publication No. WO2012/046443

[Patent Document 3] Japanese Unexamined Patent Publication No. 2019-081898

[Patent Document 4] International Publication No. WO2021/149713

### SUMMARY OF THE INVENTION

### Technical Problem

According to studies of the present inventors, it has been found that the cyclic olefin-based copolymer having a crosslinkable group as described in Patent Document 1 or Patent Document 2 has room for further improvement in solvent solubility. It is considered that in a case where the solvent solubility can be improved, it is possible to further improve the impregnability into a fiber base material in a case of manufacturing a circuit board.

In addition, it has been found that the cyclic olefin-based copolymer having a crosslinkable group, described in Patent Document 3 or Patent Document 4, is shown to have improvement in the fluidity and the solubility, but there is still room for further improvement in a varnish viscosity in a case of manufacturing the varnish in a state where a large amount of the cyclic olefin-based copolymer is included (at a high solid content). It is considered that in a case where the varnish viscosity at the high solid content can be improved, it is possible to further improve the impregnability into a fiber base material in a case of manufacturing the circuit board.

From the above, the cyclic olefin-based copolymer having a crosslinkable group has room for further improvement in that the solvent solubility is improved while maintaining excellent dielectric characteristics, and a varnish viscosity in a case of manufacturing the varnish in a state where a large amount of the cyclic olefin-based copolymer is included is reduced.

The present invention has been made in view of the circumstances, and provides a cyclic olefin-based copolymer and a cyclic olefin-based copolymer composition, which make it possible to obtain a crosslinked body having excellent dielectric characteristics in a high-frequency region suitable for a circuit board and the like, and which provide a varnish with a low viscosity even in a case of manufacturing the varnish in a state where a large amount of the cyclic olefin-based copolymer is included.

### Solution To Problem

According to the present invention, there are provided a cyclic olefin-based copolymer, a cyclic olefin-based copolymer composition, a varnish, a crosslinked body, a film or sheet, a layered product, a circuit board, an electronic device, and a prepreg.
[1]

A cyclic olefin-based copolymer including:
(A) structural units (A) derived from one or more olefins represented by General Formula (I);
(B) structural units (B) derived from one or more cyclic non-conjugated dienes represented by General Formula (II); and
(C) structural units (C) derived from one or more cyclic olefins represented by General Formula (III), in which a total of a content of the structural units (B) derived from the cyclic non-conjugated dienes and a content of the structural units (C) derived from the cyclic olefins is in a range of equal to or more than 40.0 mol % and equal to or less than 50.0 mol % in a case where a total molar amount of the structural units (A), the structural units (B), and the structural units (C) in the cyclic olefin-based copolymer is set to 100 mol %, and
a number-average molecular weight Mn of the cyclic olefin-based copolymer is equal to or more than 3,000 and equal to or less than 16,000.

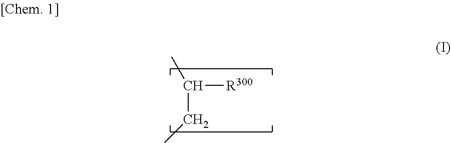

(in General Formula (I), R³⁰⁰ represents a hydrogen atom or a linear or branched hydrocarbon group having 1 to 29 carbon atoms)

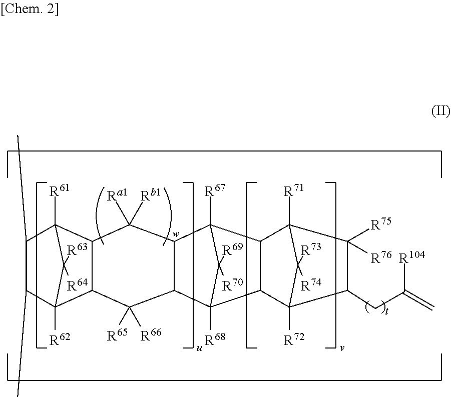

(in General Formula (II), u is 0 or 1, v is 0 or 1, w is 0 or 1, R⁶¹ to R⁷⁶ and R^{a1} and R^{b1} may be the same as or different from each other and are a hydrogen atom, a halogen atom, an alkyl group having 1 to 20 carbon atoms, a halogenated alkyl group having 1 to 20 carbon atoms, a cycloalkyl group having 3 to 15 carbon atoms, or an aromatic hydrocarbon group having 6 to 20 carbon atoms, R¹⁰⁴ is a hydrogen atom or an alkyl group having 1 to 10 carbon atoms, t is a positive integer of 0 to 10, and R⁷⁵ and R⁷⁶ may be bonded to each other to form a monocyclic ring or a polycyclic ring)

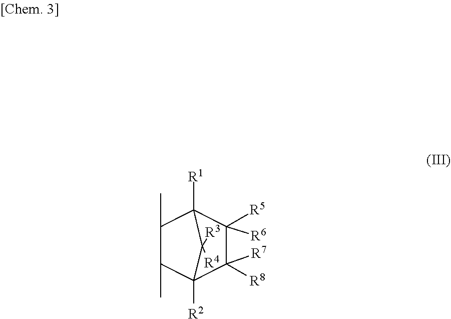

(in General Formula (III), R¹ to R⁸ are each independently a hydrogen atom, a halogen atom, or a hydrocarbon group having 4 or less carbon atoms, R⁵ to R⁸ may be bonded to each other to form a monocyclic ring, the monocyclic ring may have a double bond, and an alkylidene group may be formed between R⁵ and R⁶ or between R⁷ and R⁸).
[2]

The cyclic olefin-based copolymer according to [1],
in which
in a case where the total molar amount of the structural units (A), the structural units (B), and the structural units (C) in the cyclic olefin-based copolymer is set to 100 mol %,
the content of the structural units (B) derived from the cyclic non-conjugated dienes is equal to or more than 5 mol % and equal to or less than 40 mol %.
[3]

The cyclic olefin-based copolymer according to [1] or [2],
in which the cyclic non-conjugated diene constituting the structural units (B) derived from the cyclic non-conjugated dienes includes 5-vinyl-2-norbornene.
[4]

The cyclic olefin-based copolymer according to any one of [1] to [3],
in which the cyclic olefin constituting the structural units (C) derived from the cyclic olefins includes bicyclo[2.2.1]-2-heptene.
[5]

A cyclic olefin-based copolymer composition including:
the cyclic olefin-based copolymer according to any one of [1] to [4].
[6]

A varnish including:
the cyclic olefin-based copolymer composition according to [5]; and
a solvent.
[7]

A crosslinked body obtained by crosslinking the cyclic olefin-based copolymer composition according to [5].
[8]

A film or sheet including:
the crosslinked body according to [7].
[9]

A layered product including:
the crosslinked body according to [7].
[10]

A circuit board including:
an electrically insulating layer including the crosslinked body according to [7]; and
a conductor layer provided over the electrically insulating layer.
[11]

An electronic device including:
the circuit board according to [10].
[12]

A prepreg including:
the cyclic olefin-based copolymer according to any one of [1] to [4]; and
a sheet-like fiber base material.

### Advantageous Effects Of Invention

According to the present invention, it is possible to provide a cyclic olefin-based copolymer and a cyclic olefin-based copolymer composition, which make it possible to obtain a crosslinked body having excellent dielectric characteristics in a high-frequency region suitable for a circuit board and the like, and which provide a varnish with a low viscosity even in a case of manufacturing the varnish in a state where a large amount of the cyclic olefin-based copolymer is included.

### DESCRIPTION OF EMBODIMENTS

Hereinafter, the present invention will be described based on embodiments. Furthermore, in the present embodiment, “A to B” indicating a numerical range represents a range of equal to or more than A and equal to or less than B unless otherwise specified.

### Cyclic Olefin-Based Copolymer (m)

The cyclic olefin-based copolymer (m) according to the present embodiment is a cyclic olefin-based copolymer including (A) structural units (A) derived from one or more olefins represented by General Formula (I), (B) structural units (B) derived from one or more cyclic non-conjugated dienes represented by General Formula (II), and (C) structural units (C) derived from one or more cyclic olefins represented by General Formula (III), in which a total of a content of the structural units (B) derived from the cyclic non-conjugated dienes and a content of the structural units (C) derived from the cyclic olefins is in a range of equal to or more than 40.0 mol % and equal to or less than 50.0 mol % in a case where a total molar amount of the structural units (A), the structural units (B), and the structural units (C) in the cyclic olefin-based copolymer is set to 100 mol %, and a number-average molecular weight Mn of the cyclic olefin-based copolymer is equal to or more than 3,000 and equal to or less than 16,000.

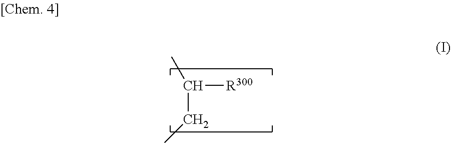

In General Formula (I), R³⁰⁰ represents a hydrogen atom or a linear or branched hydrocarbon group having 1 to 29 carbon atoms.

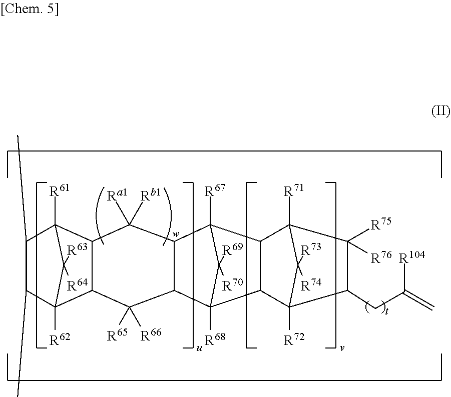

In General Formula (II), u is 0 or 1, v is 0 or a positive integer, preferably an integer of equal to or more than 0 and equal to or less than 2, and more preferably 0 or 1, w is 0 or 1, R⁶¹ to R⁷⁶ and R^{a1} and R^{b1} may be the same as or different from each other and are a hydrogen atom, a halogen atom, an alkyl group having 1 to 20 carbon atoms, a halogenated alkyl group having 1 to 20 carbon atoms, a cycloalkyl group having 3 to 15 carbon atoms, or an aromatic hydrocarbon group having 6 to 20 carbon atoms, R¹⁰⁴ is a hydrogen atom or an alkyl group having 1 to 10 carbon atoms, t is a positive integer of 0 to 10, R⁷⁵ and R⁷⁶ may be bonded to each other to form a monocyclic ring or a polycyclic ring.

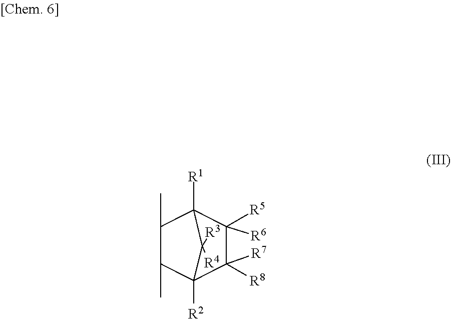

In General Formula (III), R¹ to R⁸ are each independently a hydrogen atom, a halogen atom, or a hydrocarbon group having 4 or less carbon atoms, R⁵ to R⁸ may be bonded to each other to form a monocyclic ring, the monocyclic ring may have a double bond, and an alkylidene group may be formed between R⁵ and R⁶ or between R⁷ and R⁸.

Furthermore, in the cyclic olefin copolymer (m) according to the present embodiment, the total of the content of the structural units (B) derived from the cyclic non-conjugated dienes and the content of the structural units (C) derived from the cyclic olefins is equal to or more than 40.0 mol % and equal to or less than 50.0 mol % in a case where the total molar amount of the structural units (A), the structural units (B), and the structural units (C) in the cyclic olefin copolymer (m) is set to 100 mol %.

The cyclic olefin copolymer (m) according to the present embodiment includes the structural units (A), the structural units (B), and the structural units (C), and by setting the total content of the structural units (B) and the structural units (C) to be within the ranges, a crosslinked body (Q) obtained from the cyclic olefin copolymer (m) is excellent in dielectric characteristics, and the solubility of the cyclic olefin copolymer (m) in a solvent is further improved. Thus, the moldability is improved and the yield of a product is enhanced. In other words, according to the present embodiment, it is possible to provide a cyclic olefin copolymer (m) and a cyclic olefin-based resin composition, which are excellent in the solubility in a case of manufacturing a varnish in a state where a large amount of the cyclic olefin-based copolymer is included, while maintaining excellent dielectric characteristics.

In this case, from the viewpoint of further improving a performance balance between the dielectric characteristics and the solubility, a lower limit value of the total of the content of the structural units (B) derived from a cyclic non-conjugated diene and the content of the structural units (C) derived from the cyclic olefins is preferably equal to or more than 40.5 mol %, and more preferably equal to or more than 41.0 mol %. In addition, from the viewpoint of further improving the performance balance between the dielectric characteristics and the solubility, an upper limit value of the total of the content of the structural units (B) derived from the cyclic non-conjugated dienes and the content of the structural units (C) derived from the cyclic olefins is preferably equal to or less than 49.0 mol %, more preferably equal to or less than 48.0 mol %, even more preferably equal to or less than 47.5 mol %, even more preferably equal to or less than 47.0 mol %, even more preferably equal to or less than 46.0 mol %, even more preferably equal to or less than 45.0 mol %, even more preferably equal to or less than 44.0 mol %, and even more preferably equal to or less than 43.5 mol %.

Furthermore, the cyclic olefin copolymer (m) according to the present embodiment has a number-average molecular weight Mn of equal to or more than 3,000 and equal to or less than 16,000.

In a case where the cyclic olefin copolymer (m) according to the present embodiment has the number-average molecular weight Mn within the ranges, the crosslinked body (Q) obtained from the cyclic olefin copolymer (m) is excellent in dielectric characteristics, and the solubility of the cyclic olefin copolymer (m) in a solvent is further improved. Therefore, the moldability is improved and the yield of a product is enhanced. In other words, according to the present embodiment, it is possible to provide a cyclic olefin copolymer (m) and a cyclic olefin-based resin composition, which are excellent in solubility in a case where a varnish is manufactured in a state where a large amount of the cyclic olefin-based copolymer is included, while maintaining excellent dielectric characteristics.

In this case, a lower limit value of the number-average molecular weight Mn is preferably equal to or more than 4,000, more preferably equal to or more than 5,000, even more preferably equal to or more than 6,000, even more preferably equal to or more than 7,000, and even more preferably equal to or more than 7,300. In a case where the number-average molecular weight Mn of the cyclic olefin-based copolymer (m) is equal to or more than the lower limit value, it is possible to further improve the dielectric characteristics, heat resistance, and mechanical characteristics of the crosslinked body (Q) obtained by crosslinking the cyclic olefin-based copolymer (m) or the cyclic olefin-based copolymer composition according to the present embodiment.

In addition, an upper limit value of the number-average molecular weight Mn is preferably equal to or less than 15,000, more preferably equal to or less than 12,000, even more preferably equal to or less than 11,500, and even more preferably equal to or less than 11,200. In a case where the number-average molecular weight Mn of the cyclic olefin-based copolymer (m) is equal to or less than the upper limit value, it is possible to improve the moldability such as impregnability into a fiber base material and wire embedding properties of the cyclic olefin-based copolymer (m) or the cyclic olefin-based copolymer composition according to the present embodiment during the manufacture of a circuit board.

### <Structural Units (A) >

In General Formula (I), R³⁰⁰ represents a hydrogen atom or a linear or branched hydrocarbon group having 1 to 29 carbon atoms.

Aan olefin monomer for forming the structural unit (A) include, for example, ethylene, propylene, 1-butene, 1-pentene, 1-hexene, 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 1-octene, 1-decene, 1-dodecene, 1-tetradecene, 1-hexadecene, 1-octadecene, and 1-eicosene.

From the viewpoint of obtaining a crosslinked body having excellent heat resistance, mechanical characteristics, dielectric characteristics, transparency, and gas barrier properties, among the olefin monomers, ethylene or propylene is preferable and ethylene is more preferable. The olefin monomers for forming the structural units (A) may be used alone or in combination of two or more kinds thereof.

In the cyclic olefin-based copolymer (m) according to the present embodiment, the content of the structural units (A) is preferably equal to or more than 20 mol % and equal to or less than 60 mol %, more preferably equal to or more than 30 mol % and equal to or less than 60 mol %, even more preferably equal to or more than 40 mol % and equal to or less than 59 mol %, even more preferably equal to or more than 45 mol % and equal to or less than 59 mole, even more preferably equal to or more than 50 mol % and equal to or less than 58 mol %, and even more preferably equal to or more than 52 mol % and equal to or less than 57 mol % in a case where the total molar amount of the structural units (A), the structural units (B), and the structural units (C) in the cyclic olefin copolymer (m) is set to 100 mol %. By setting the content of the structural units (A) to be within the numerical ranges, the solubility of the cyclic olefin-based copolymer according to the present embodiment in a solvent is further improved.

In addition, in the cyclic olefin-based copolymer (m) according to the present embodiment, from the viewpoint of further improving the solubility of the cyclic olefin-based copolymer according to the present embodiment in a solvent, a lower limit value of the content of the structural units (A) is preferably equal to or more than 20 mol %, more preferably equal to or more than 30 mol %, even more preferably equal to or more than 40 mol %, even more preferably equal to or more than 45 mol %, even more preferably equal to or more than 50 mol %, and even more preferably equal to or more than 52 mol % in a case where the total molar amount of the structural units (A), the structural units (B), and the structural units (C) in the cyclic olefin copolymer (m) is set to 100 mol %.

Furthermore, from the viewpoint of further improving the solubility of the cyclic olefin-based copolymer according to the present embodiment in a solvent, an upper limit value of the content of the structural units (A) is preferably equal to or less than 60 mol %, more preferably equal to or less than 59 mol %, even more preferably equal to or less than 58 mol %, and even more preferably equal to or less than 57 mol %. Incidentally, it is possible to measure the content of the structural units (A) by ¹H-NMR.

### <Structural Units (B) >

The cyclic non-conjugated diene monomer, which is the copolymerization raw material of the cyclic olefin-based copolymer (m) according to the present embodiment, is addition copolymerized to form a structural unit represented by Formula (II). Specifically, a cyclic non-conjugated diene represented by General Formula (IIa) corresponding to General Formula (II) is used.

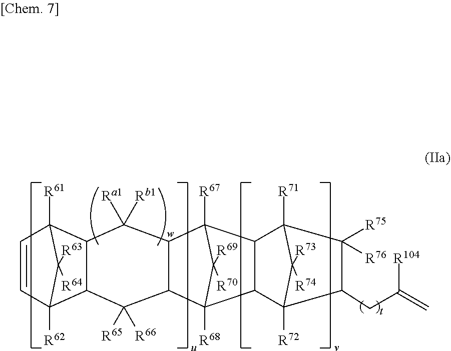

In General Formula (IIa), u is 0 or 1, v is 0 or 1, w is 0 or 1, R⁶¹ to R⁷⁶ and R^{a1} and R^{b1} may be the same as or different from each other and are a hydrogen atom, a halogen atom, an alkyl group having 1 to 20 carbon atoms, a halogenated alkyl group having 1 to 20 carbon atoms, a cycloalkyl group having 3 to 15 carbon atoms, or an aromatic hydrocarbon group having 6 to 20 carbon atoms, R¹⁰⁴ is a hydrogen atom or an alkyl group having 1 to 10 carbon atoms, t is a positive integer of 0 to 10, and R⁷⁵ and R⁷⁶ may be bonded to each other to form a monocyclic ring or a polycyclic ring.

The cyclic non-conjugated diene represented by General Formula (IIa) is not particularly limited and examples thereof include the cyclic non-conjugated dienes represented by the chemical formulae below.

Among the above, at least one selected from 5-vinyl-2-norbornene and 8-vinyl-9-methyltetracyclo[4.4.0.1^{2,5}.1^{7,10}]-3-dodecene is preferable, and 5-vinyl-2-norbornene is more preferable.

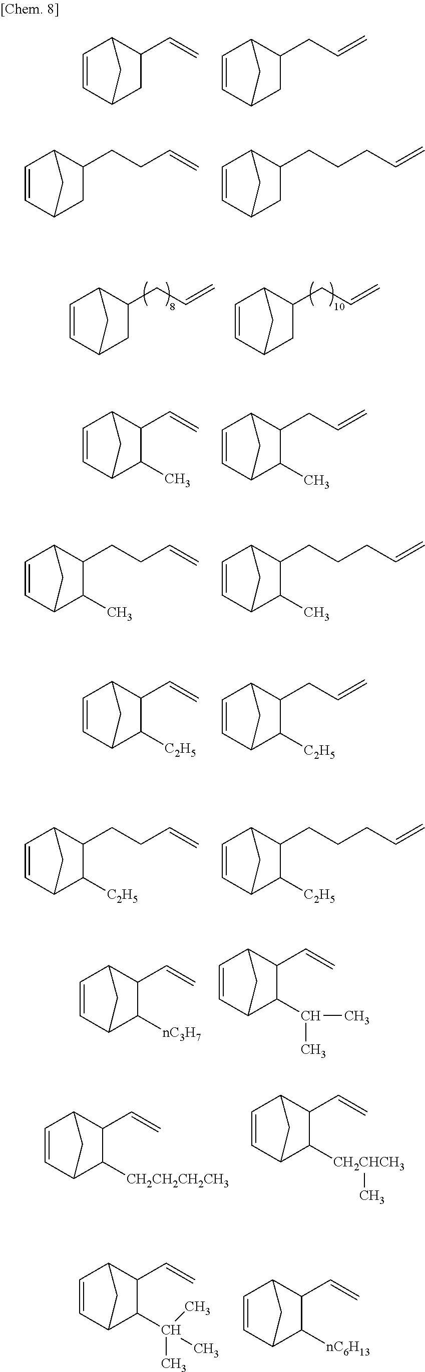

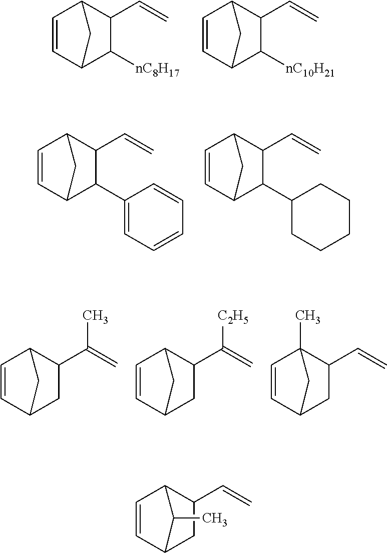

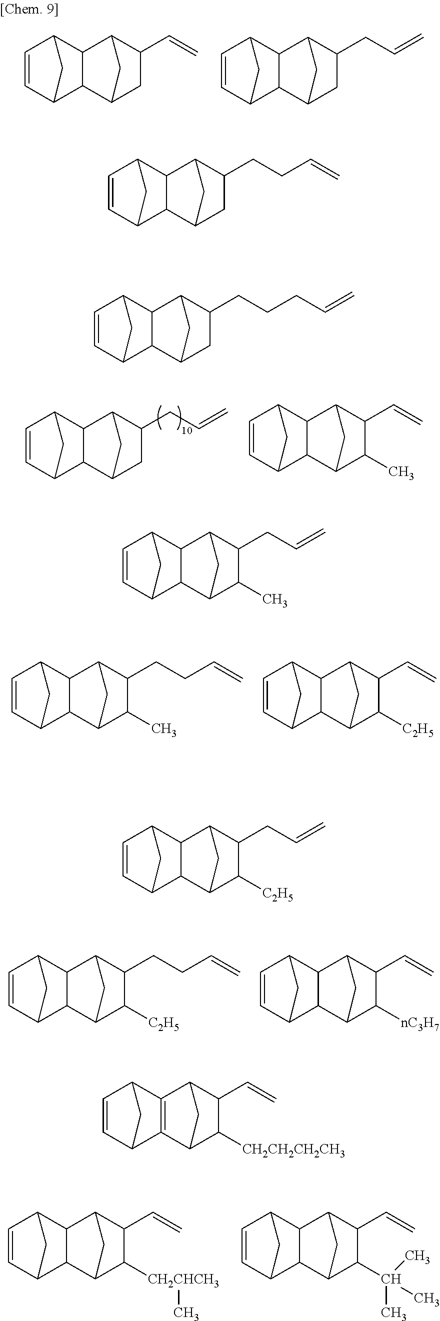

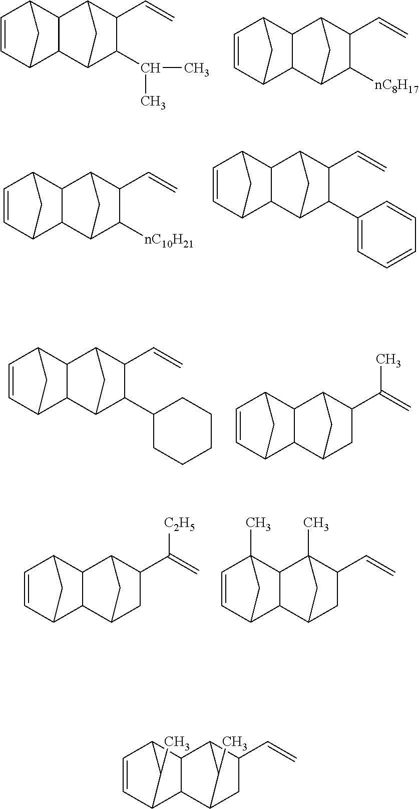

The cyclic non-conjugated diene represented by General

Formula (IIa) can also be specifically represented by General Formula (IIb).

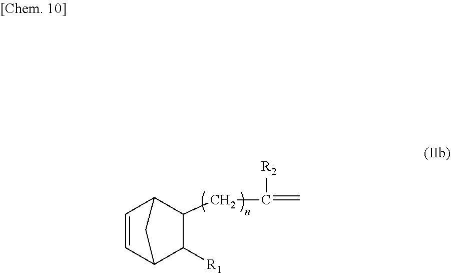

n in General Formula (IIb) is an integer of 0 to 10, R¹ is a hydrogen atom or an alkyl group having 1 to 10 carbon atoms, and R² is a hydrogen atom or an alkyl group having 1 to 5 carbon atoms.

By configuring the cyclic olefin copolymer (m) according to the present embodiment to include the structural units derived from the cyclic non-conjugated dienes represented by General Formula (II), the cyclic olefin copolymer (m) has a double bond in a side chain portion, that is, a portion other than the main copolymerization chain.

In the cyclic olefin-based copolymer (m) according to the present embodiment, the content of the structural units (B) is preferably equal to or more than 1 mol % and equal to or less than 40 mol %, more preferably equal to or more than 1 mol % and equal to or less than 35 mol %, even more preferably equal to or more than 3 mol % and equal to or less than 30 mol %, even more preferably equal to or more than 3 mol % and equal to or less than 25 mol %, even more preferably equal to or more than 5 mol % and equal to or less than 20 mol %, even more preferably equal to or more than 7 mol % and equal to or less than 17 mol %, and even more preferably equal to or more than 10 mol % and equal to or less than 15 mol % in a case where the total molar amount of structural units in the cyclic olefin copolymer (m) is set to 100 mol %. By setting the content of the structural units (B) to be within the numerical ranges, the solubility of the cyclic olefin-based copolymer according to the present embodiment in a solvent is further improved.

In addition, in the cyclic olefin-based copolymer (m) according to the present embodiment, from the viewpoint of further improving the solubility of the cyclic olefin-based copolymer according to the present embodiment in a solvent, a lower limit value of the content of the structural units (B) is preferably equal to or more than 1 mol %, more preferably equal to or more than 3 mol %, even more preferably equal to or more than 5 mol %, even more preferably equal to or more than 7 mole, and even more preferably equal to or more than 10 mol % in a case where the total molar amount of the structural units in the cyclic olefin copolymer (m) is set to 100 mol %.

Furthermore, from the viewpoint of further improving the solubility of the cyclic olefin-based copolymer according to the present embodiment in a solvent, an upper limit value of the content of the structural units (B) is preferably equal to or less than 40 mol %, more preferably equal to or less than 35 mol %, still more preferably equal to or less than 30 mol %, even more preferably equal to or less than 25 mol %, still more preferably equal to or less than 20 mol %, even more preferably equal to or less than 17 mol %, and still more preferably equal to or less than 15 mol %.

Incidentally, the content of the structural units (B) can be measured by ¹H-NMR.

### <Structural Units (C) >

In General Formula (III), R¹ to R⁸ are each independently a hydrogen atom, a halogen atom, or a hydrocarbon group having 4 or less carbon atoms. Here, the halogen atom is a fluorine atom, a chlorine atom, a bromine atom, or an iodine atom. Examples of the hydrocarbon group having 4 or less carbon atoms include alkyl groups such as a methyl group, an ethyl group, a propyl group, an isopropyl group, an n-butyl group, and an isobutyl group, and cycloalkyl groups such as a cyclopropyl group.

In addition, R⁵ to R⁸ may be bonded to each other to form a monocyclic ring, the monocyclic ring may have a double bond, and R⁵ and R⁶ or R⁷ and R⁸ may form an alkylidene group.

Examples of the monocyclic ring thus formed are shown below.

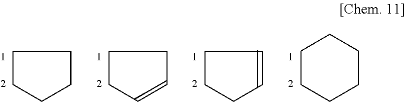

Furthermore, in the monocyclic ring, the carbon atom numbered 1 or 2 is a carbon atom that forms an alicyclic structure to which R⁵ (R⁶) or R⁷ (R⁸) is bonded in General Formula (II).

In addition, specific examples of the alkylidene group include an ethylidene group, a propylidene group, and an isopropylidene group.

The cyclic olefin monomers for forming the structural units (C) include, for example, bicyclo [2.2.1]-2-heptene (also referred to as 2-norbornene) and alkyl-and/or alkylidene-substituted derivatives of the bicyclo [2.2.1]-2-heptene, such as 5-methyl-2-norbornene, 5-dimethyl-2-norbornene, 5-ethyl-2-norbornene, 5-butyl-2-norbornene, and 5-ethylidene-2-norbornene, and derivatives of the bicyclo [2.2.1]-2-heptene, substituted with polar groups such as halogen, dicyclopentadiene and 2,3-dihydrodicyclopentadiene; dimethanooctahydronaphthalene, alkyl- and/or alkylidene-substituted derivatives of the dimethanooctahydronaphthalene, and derivatives of the dimethanooctahydronaphthalene, substituted with a polar group such as halogen, a carboxyl group, and cyano group, for example, 6-methyl-1, 4:5, 8-dimethano-1, 4, 4a, 5, 6, 7, 8, 8a-octahydronaphthalene, 6-ethyl-1, 4:5, 8-dimethano-1, 4, 4a, 5, 6, 7, 8, 8a-octahydronaphthalene, 6-ethylidene-1, 4:5, 8-dimethano-1, 4, 4a, 5, 6, 7, 8, 8a-octahydronaphthalene, 6-chloro-1, 4:5, 8-dimethano-1, 4, 4a, 5, 6, 7, 8, 8a-octahydronaphthalene, 6-chloro-1, 4:5, 8-dimethano-1, 4, 4a, 5, 6, 7, 8, 8a-octahydronaphthalene, 6-cyano-1, 4:5, 8-dimethano-1, 4, 4a, 5, 6, 7, 8, 8a-octahydronaphthalene, 6-pyridyl-1, 4:5, 8-dimethano-1, 4,4a, 5, 6, 7, 8, 8a-octahydronaphthalene, and 6-methoxycarbonyl-1, 4:5, 8-dimethano-1, 4, 4a, 5, 6, 7, 8, 8a-octahydronaphthalene; adducts of cyclopentadiene with tetrahydroindene and the like; trimers and tetramers of cyclopentadiene, for example, 4, 9:5, 8-dimethano-3a, 4, 4a, 5, 8, 8a, 9, 9a-octahydro-1H-benzoindene, 4, 11:5, 10:6, 9-trimethano-3a, 4, 4a, 5, 5a, 6, 9, 9a, 10, 10a, 11, 11a-dodecahydro-1H-cyclopentaanthracene, 5-carboxymethylbicyclo[2.2.1]hept-2-ene, 5-methyl-5-carboxymethylbicyclo[2.2.1]hept-2-ene, 5-cyanobicyclo[2.2.1]hept-2-ene, 8-carboxymethyltetracyclo[4.4.0.1^{2,5}.1^{7,10}]-3-dodecene, 8-carboxyethyltetracyclo[4. 4. 0. 12, 5. 17, 10]-3-dodecene, 8-carboxy n-propyltetracyclo[4.4.0.1^{2,5}.1^{7,10}]-3-dodecene, 8-carboxyisopropyltetracyclo[4.4.0.1^{2,5}.1^{7,10}]-3-dodecene, 8-carboxyn-butyltetracyclo[4.4.0.1^{2,5}.1^{7,10}]-3-dodecene, 8-methyl-8-carboxymethyltetracyclo[4.4.0.1^{2,5}.1^{7,10}]-3-dodecene, 8-methyl-8-carboxyethyltetracyclo[4.4.0.1^{2,5}.1^{7,10}]-3-dodecene, 8-methyl-8-carboxy n-propyltetracyclo[4.4.0.1^{2,5}.1^{7,10}]-3-dodecene, 8-methyl-8-carboxyisopropyltetracyclo[4.4.0.1^{2,5}.1^{7,10}]-3-dodecene, and 8-methyl-8-carboxy n-butyltetracyclo[4.4.0.1^{2,5}.1^{7,10}]-3-dodecene. Among these, bicyclo[2.2.1]-2-heptene is preferable.

As the cyclic olefin monomers for forming the structural units (C), the cyclic olefin monomers may be used alone or in combination of two or more kinds thereof.

In the cyclic olefin-based copolymer (m) according to the present embodiment, the content of the structural units (C) is preferably equal to or more than 5 mol % and equal to or less than 40 mol %, more preferably equal to or more than 10 mol % and equal to or less than 38 mol %, even more preferably equal to or more than 13 mol % and equal to or less than 38 mol %, even more preferably equal to or more than 15 mol % and equal to or less than 35 mol %, even more preferably equal to or more than 20 mol % and equal to or less than 35 mol %, and even more preferably equal to or more than 21 mol % and equal to or less than 35 mol % in a case where the total molar amount of the structural units (A), the structural units (B), and the structural units (C) in the cyclic olefin copolymer (m) is set to 100 mol %. In a case where the content of the structural units (C) is within the numerical ranges, the solubility of the cyclic olefin-based copolymer according to the present embodiment in a solvent is further improved.

In addition, in the cyclic olefin-based copolymer (m) according to the present embodiment, from the viewpoint of further improving the solubility of the cyclic olefin-based copolymer according to the present embodiment in a solvent, a lower limit value of the content of the structural units (C) is preferably equal to or more than 5 mol %, more preferably equal to or more than 10 mol %, even more preferably equal to or more than 13 mol %, even more preferably equal to or more than 15 mol %, even more preferably equal to or more than 20 mol %, and even more preferably equal to or more than 21 mol % in a case where the total molar amount of the structural units (A), the structural units (B), and the structural units (C) in the cyclic olefin copolymer (m) is set to 100 mol %.

Furthermore, from the viewpoint of further improving the solubility of the cyclic olefin-based copolymer according to the present embodiment in a solvent, an upper limit value of the content of the structural units (C) is preferably equal to or less than 40 mol %, more preferably equal to or less than 39 mol %, even more preferably equal to or less than 38 mol %, even more preferably equal to or less than 37 mol %, and even more preferably equal to or less than 35 mol %.

Incidentally, the content of the structural units (C) can be measured by ¹H-NMR.

### <Structural Units (D) >

The cyclic olefin-based copolymer (m) according to the present embodiment may further include structural units derived from one or more kinds of cyclic olefins represented by General Formula (V).

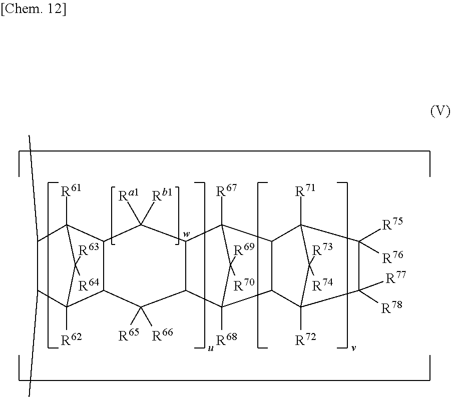

In General Formula (V), u is 0 or 1, v is 0 or a positive integer, preferably an integer of equal to or more than 0 and equal to or less than 2, and more preferably 0 or 1, u+v is a positive integer, w is 0 or 1, R⁶¹ to R⁷⁸ and R^{a1} and R^{b1} may be the same as or different from each other and are a hydrogen atom, a halogen atom, an alkyl group having 1 to 20 carbon atoms, a halogenated alkyl group having 1 to 20 carbon atoms, a cycloalkyl group having 3 to 15 carbon atoms, or an aromatic hydrocarbon group having 6 to 20 carbon atoms, and R⁷⁵ to R⁷⁸ may be bonded to each other to form a monocyclic ring or a polycyclic ring.

Specifically, a cyclic olefin monomer represented by General Formula (Va) corresponding to General Formula (V) is used.

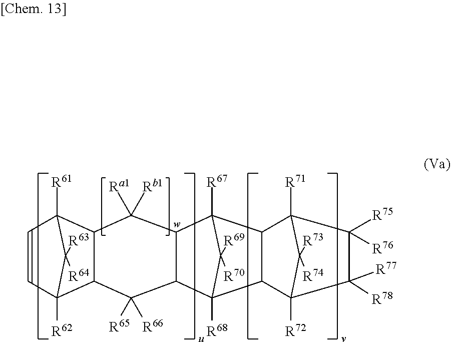

In General Formula (Va), u is 0 or 1, v is 0 or a positive integer, preferably an integer of equal to or more than 0 and equal to or less than 2, and more preferably 0 or 1, u+v is a positive integer, w is 0 or 1, R⁶¹ to R⁷⁸ and R^{a1} and R^{b1} may be the same as or different from each other and are a hydrogen atom, a halogen atom, an alkyl group having 1 to 20 carbon atoms, a halogenated alkyl group having 1 to 20 carbon atoms, a cycloalkyl group having 3 to 15 carbon atoms, or an aromatic hydrocarbon group having 6 to 20 carbon atoms, and R⁷⁵ to R⁷⁸ may be bonded to each other to form a monocyclic ring or a polycyclic ring.

As specific examples of the cyclic olefin represented by General Formula (Va), the compounds described in International Publication No. WO2006/118261 can be used.

As the cyclic olefin represented by General Formula (Va), tetracyclo[4.4.0.1^{2,5}.1^{7, 10}]-3-dodecene (also referred to as tetracyclododecene) is preferable. Since the tetracyclododecene has a rigid ring structure, the moduli of elasticity of the copolymer and the crosslinked body are easily retained, and since the tetracyclododecene does not include a heterogeneous double bond structure, there is an advantage in that the crosslinking is easily controlled.

In the cyclic olefin-based copolymer (m) according to the present embodiment, the content of the structural units (D) is preferably equal to or more than 1 mol % and equal to or less than 35 mol %, more preferably equal to or more than 3 mol % and equal to or less than 25 mol %, and still more preferably equal to or more than 5 mol % and equal to or less than 15 mol % in a case where the total molar amount of the structural units (A), the structural units (B), and the structural units (C) in the cyclic olefin copolymer is set to 100 mol %. In a case where the content of the structural units (D) is within the numerical ranges, the solubility of the cyclic olefin-based copolymer according to the present embodiment in a solvent is further improved.

Incidentally, the content of the structural units (D) can be measured by ¹H-NMR.

From the viewpoint of further improving the performance balance between the dielectric characteristics and the solubility, the total content of the structural units (A), the structural units (B), and the structural units (C) in the cyclic olefin-based copolymer (m) according to the present embodiment is preferably equal to or more than 65 mol %, more preferably equal to or more than 75 mol %, still more preferably equal to or more than 85 mol %, still more preferably equal to or more than 95 mol %, even more preferably equal to or more than 97 mol %, and still more preferably equal to or more than 99 mol %, and is preferably equal to or less than 100 mol % in a case where the total molar amount of all structural units in the cyclic olefin copolymer (m) is set to 100 mol %.

### Method for Producing Cyclic Olefin Copolymer (m)

The cyclic olefin copolymer (m) according to the present embodiment can be produced by, for example, according to the method for producing a cyclic olefin copolymer described in paragraphs 0075 to 0219 of International Publication No. WO2012/046443. Details thereof will not be repeated here.

### Cyclic Olefin-Based Resin Composition

The cyclic olefin-based resin composition according to the present embodiment includes the cyclic olefin copolymer (m) according to the present embodiment.

In addition, various additives may be added to the cyclic olefin-based resin composition according to the present embodiment according to the purpose. The amounts of the additives to be added are appropriately selected according to uses within a range in which the purpose of the present invention is not impaired.

Examples of the additives include one or two or more additives selected from the group consisting of a radical polymerization initiator, an elastomer, a heat resistant stabilizer, a weather stabilizer, a radiation resistance agent, a plasticizer, a lubricant, a mold releasing agent, a nucleating agent, a friction and wear property improver, a flame retardant, a foaming agent, an anti-static agent, a coloring agent, an anti-fogging agent, an anti-blocking agent, an anti-impact agent, a surface wetting improver, a filler, a hydrochloric acid absorber, and a metal deactivator.

The cyclic olefin-based resin composition according to the present embodiment can be prepared by, for example, mixing the cyclic olefin copolymer (m), and various additives as necessary. As the mixing method, it is possible to adopt a method in which melt-blending is performed with an extruder and the like, a solution blending method in which dissolution and dispersion are performed in a suitable solvent, for example, a saturated hydrocarbon such as heptane, hexane, decane, and cyclohexane; or an aromatic hydrocarbon such as toluene, benzene, and xylene; and the like.

The cyclic olefin-based resin composition according to the present embodiment can be formed to be varnish-like by mixing with a solvent.

A solvent for preparing the varnish-like cyclic olefin-based resin composition is not particularly limited as long as it does not impair the solubility or the affinity with respect to the cyclic olefin copolymer (m). As the solvent which is preferably used, saturated hydrocarbons such as heptane, hexane, octane, and decane; alicyclic hydrocarbons such as cyclohexane, methylcyclohexane, and decahydronaphthalene; aromatic hydrocarbons such as toluene, benzene, xylene, mesitylene, and pseudocumene; alcohols such as methanol, ethanol, isopropyl alcohol, butanol, pentanol, hexanol, propanediol, and phenol;

ketone solvents such as acetone, methyl isobutyl ketone, methyl ethyl ketone, pentanone, hexanone, cyclohexanone, isophorone, and acetophenone; cellosolves such as methyl cellosolve and ethyl cellosolve; esters such as methyl acetate, ethyl acetate, butyl acetate, methyl propionate, and butyl formate; or halogenated hydrocarbons such as trichloroethylene, dichloroethylene, and chlorobenzene are used. Heptane, decane, cyclohexane, methylcyclohexane, decahydronaphthalene, toluene, benzene, xylene, mesitylene, or pseudocumene is preferably used. These solvents can be alone or as a mixture of two or more kinds at any proportion.

In the present embodiment, a method for manufacturing the varnish-like cyclic olefin-based resin composition may be carried out by any method, but usually includes a step of mixing the cyclic olefin copolymer (m) and a solvent. The order of the components in the mixing of the respective components is not limited and the mixing can be carried out by any manner, such as all at once or in portions. A device for preparing the varnish is also not limited and the preparation may be carried out by any device in a batch type or continuous type, with which stirring and mixing can be performed. It is possible to optionally select the temperature in a case where the varnish is prepared within a range from room temperature to the boiling point of the solvent.

Incidentally, the varnish may be prepared by using a reaction solution as the solvent as it is in a case where the cyclic olefin copolymer (m) can be obtained.

### Crosslinked Body (Q)

The crosslinked body (Q) according to the present embodiment is obtained by crosslinking the cyclic olefin copolymer (m) according to the present embodiment or the cyclic olefin-based resin composition according to the present embodiment. A method for crosslinking the cyclic olefin copolymer (m) according to the present embodiment or the cyclic olefin-based resin composition according to the present embodiment is not particularly limited, and examples thereof include a method for performing crosslinking while or after performing molding into any shape, using a radical polymerization initiator, sulfur, a hydrosilyl group-containing compound, electron beams, or other radiation.

In a case of performing crosslinking with a radical polymerization initiator, it is possible to directly apply a crosslinking method using a normal radical polymerization initiator applied using a polyolefin. That is, a radical polymerization initiator such as dicumyl peroxide is blended into the cyclic olefin copolymer (m) or the cyclic olefin-based resin composition, heated, and subjected to crosslinking. A content of the radical polymerization initiator is not particularly limited, but is usually 0.02 to 20 parts by mass, preferably 0.05 to 10 parts by mass, more preferably 0.5 to 10 parts by mass, still more preferably 1.0 to 5 parts by mass, even more preferably 1.5 to 3 parts by mass, and still more preferably 2.0 to 2.5 parts by mass with respect to 100 parts by mass of the cyclic olefin copolymer (m). In a case where the content of the radical polymerization initiator is equal to or less than the upper limit value, it is possible to improve the dielectric characteristics of the crosslinked body (Q), and in a case where the content is equal to or more than the lower limit value, it is possible to improve the heat resistance and the mechanical characteristics of the crosslinked body (Q).

In addition, from the viewpoint of further improving the dielectric characteristics of the crosslinked body (Q), an upper limit value of the content of the radical polymerization initiator is preferably equal to or more than 0.02 parts by mass, more preferably equal to or more than 0.05 parts by mass, even more preferably equal to or more than 0.1 parts by mass, even more preferably equal to or more than 0.5 parts by mass, even more preferably equal to or more than 1.0 parts by mass, even more preferably equal to or more than 1.5 parts by mass, and even more preferably equal to or more than 2.0 parts by mass with respect to 100 parts by mass of the cyclic olefin copolymer (m).

Furthermore, from the viewpoint of further improving a performance balance of the heat resistance and the mechanical characteristics of the crosslinked body (Q), a lower limit value of the content of the radical polymerization initiator is preferably equal to or less than 20 parts by mass, more preferably equal to or less than 10 parts by mass, even more preferably equal to or less than 5 parts by mass, even more preferably equal to or less than 3 parts by mass, and even more preferably equal to or less than 2.5 parts by mass.

As the radical polymerization initiator, a known thermal radical polymerization initiator, a photoradical polymerization initiator, or a combination thereof can be used. Among these radical polymerization initiators, in a case where a thermal radical polymerization initiator is used, the 10-hour half-life temperature thereof is usually 80° C. or higher and preferably 120° C. or higher from the viewpoint of further improving the storage stability. Such a thermal radical polymerization initiator include, for example, dialkyl peroxides such as dicumyl peroxide, t-butyl cumyl peroxide, 2, 5-bis(t-butylperoxy) 2, 5-dimethylhexane, 2, 5-bis(t-butylperoxy) 2, 5-dimethyl hexyne-3, di-t-butyl peroxide, isopropyl cumyl-t-butyl peroxide, and bis(α-t-butylperoxy isopropyl)benzene; peroxy ketals such as 1, 1-bis(t-butylperoxy) cyclohexane, 1, 1-bis(t-butylperoxy) 3, 3, 5-trimethylcyclohexane, 1, 1-bis(t-butylperoxy) cyclododecane, n-butyl-4, 4-bis(t-butylperoxy) valerate, ethyl 3, 3-bis(t-butylperoxy) butyrate, 3, 3, 6, 6, 9, 9-hexamethyl-1, 2, 4, 5-tetraoxycyclononane; peroxy esters such as bis(t-butylperoxy) isophthalate, t-butylperoxybenzoate, and t-butylperoxyacetate; hydroperoxides such as t-butyl hydroperoxide, t-hexyl hydroperoxide, cumin hydroperoxide, 1, 1, 3, 3-tetramethylbutyl hydroperoxide, diisopropylbenzene hydroperoxide, and p-menthane hydroperoxide; bibenzyl compounds such as 2, 3-dimethyl-2, 3-diphenylbutane; and 3, 3,5, 7, 7-pentamethyl-1, 2, 4-trioxepane.

A commercially available product of the thermal radical polymerization initiator include, for example, “PERCUMYL P”, “PERCUMYL D”, “PERBUTYL C”, “PERBUTYL A”, “PERBUTYL P”, “PERBUTYL L”, “PERBUTYL O”, “PERBUTYL ND”, and “PERBUTYL Z”, manufactured by NOF Corporation.

The photoradical polymerization initiator among the radical polymerization initiators specifically include, for example, benzoin alkyl ether, benzyl dimethyl ketal, 1-hydroxycyclohexyl phenyl ketone, 2-hydroxy-2-methyl-1-phenylpropan-1-one, benzophenone, methyl benzoyl formate, isopropyl thioxantone, and a mixture of two or more kinds thereof. In addition, a sensitizer can also be used together with the photoradical polymerization initiator. Examples of the sensitizer include carbonyl compounds such as anthraquinone, 1,2-naphthoquinone, 1,4-naphthoquinone, benzanthrone, p,p′-tetramethyldiaminobenzophenone, and chloranil, nitro compounds such as nitrobenzene, p-dinitrobenzene, and 2-nitrofluorene, aromatic hydrocarbons such as anthracene and chrysene, sulfur compounds such as diphenyldisulfide, and nitrogen compounds such as nitroaniline, 2-chloro-4-nitroaniline, 5-nitro-2-aminotoluene, and tetracyanoethylene.

In a case of performing crosslinking with sulfur and the like, the cyclic olefin-based resin composition is blended with a sulfur-based compound, and as necessary, a vulcanization accelerator and a vulcanization acceleration aid, and heated to perform a crosslinking reaction. A content of the sulfur-based compound is not particularly limited, but from the viewpoint of making the crosslinking reaction efficiently proceed, improving the physical properties of the obtained crosslinked body, and economic efficiencies, the sulfur-based compound is usually used in an amount in a range of 0.1 to 10 parts by mass, and preferably 0.3 to 5 parts by mass with respect to 100 parts by mass of the cyclic olefin copolymer (m). In addition, in a case where a vulcanization accelerator or a vulcanization acceleration aid is used in combination, it is usually used in an amount in a range of 0.1 to 20 parts by mass, and preferably in a range of 0.2 to 10 parts by mass.

Various known sulfur-based compounds can be used to cause the crosslinking reaction, and examples thereof include sulfur, sulfur monochloride, sulfur dichloride, morpholine disulfide, alkylphenol disulfide, tetramethylthiuram disulfide, and selenium dimethyldithiocarbamate. In addition, various vulcanization accelerators can also be used, and examples thereof include thiazole-based vulcanization accelerators such as N-cyclohexyl-2-benzothiazole-sulfenamide, N-oxydiethylene-2-benzothiazole-sulfenamide, N, N-diisopropyl-2-benzothiazole sulfenamide, 2-mercaptobenzothiazole, 2-(2,4-dinitrophenyl)mercaptobenzothiazole, 2-(2,6-diethyl-4-morpholinothio)benzothiazole, and benzothiazyl-disulfide; guanidine-based vulcanization accelerators such as diphenyl guanidine, triphenyl guanidine, di-ortho-tolyl guanidine, ortho-tolyl biguanide, and diphenyl guanidine phthalate; an acetoldehyde-aniline reaction product; a butyraldehyde-aniline condensate; an aldehyde amine-or aldehyde ammonia-based vulcanization accelerators such as hexamethylenetetramine and acetoaldehyde ammonia; imidazoline-based vulcanization accelerators such as 2-mercaptoimidazoline; thiourea-based vulcanization accelerators such as thiocarbanilide, diethyl thiourea dibutyl thiourea, trimethyl thiourea, and diortho-tolyl thiourea; thiuram-based vulcanization accelerators such as tetramethyl thiuram monosulfide, tetramethylthiuram disulfide, tetraethylthiuram disulfide, tetrabutylthiuram disulfide, and dipentamethylenethiuram tetrasulfide; dithio acid salt-based vulcanization accelerators such as zinc dimethyldithiocarbamate, zinc diethylthiocarbamate, zinc di-n-butyldithiocarbamate, zinc ethylphenyldithiocarbamate, zinc butylphenyldithiocarbamate, sodium dimethyldithiocarbamate, selenium dimethyldithiocarbamate, and tellurium diethyldithiocarbamate; and xanthate-based vulcanization accelerators such as zinc dibutyl xanthate. Examples of the vulcanization acceleration aid include metal oxide-based vulcanization acceleration aids such as zinc oxide, activated zinc oxide, zinc carbonate, complex zinc oxide, magnesium oxide, litharge, red lead, and basic lead carbonate, fatty acid-based vulcanization acceleration aids such as stearic acid, oleic acid, lauric acid, and lead stearate, and organic amine glycol-based vulcanization acceleration aids such as triethanol amine, and diethylene glycol.

A temperature at which the cyclic olefin copolymer (m) or the cyclic olefin-based resin composition is crosslinked with the radical polymerization initiator or sulfur is usually 100° C. to 300° C., preferably 120° C. to 250° C., and more preferably 120° C. to 220° C., and the temperature may be changed in stages to perform the crosslinking. In a case where the temperature is equal to or more than the lower limit value, it is possible for the crosslinking to proceed sufficiently. In addition, in a case where the temperature is equal to or less than the upper limit value, it is possible to suppress the coloration of the obtained crosslinked body and to simplify the process. Furthermore, as a reference, it is generally not possible for polybutadiene, which is a typical double bond-containing polymer, to be crosslinked under the conditions as described above and crosslinking conditions at a high temperature such as 300° C. are required.

The cyclic olefin copolymer (m) or the cyclic olefin-based resin composition according to the present embodiment can also be crosslinked using a hydrosilyl group-containing compound having at least two hydrosilyl groups in one molecule. It is possible to perform the crosslinking using the hydrosilyl group-containing compound according to, for example, the method described in Japanese Unexamined Patent Publication No. 2015-193680. Details thereof will not be repeated here.

Methods for crosslinking using electron beams or other radiation have an advantage in that the temperature and the fluidity at the time of molding are not limited, and examples of the radiation include y rays, and UV, in addition to electron beams.

In either case of the method using the radical polymerization initiator, sulfur, the hydrosilyl group-containing compound, or the like, or the method for crosslinking using the radiation, it is possible to perform the crosslinking in combination with a crosslinking aid.

The crosslinking aid is not particularly limited, and examples thereof include oximes such as p-quinonedioxime and p,p′-dibenzoylquinonedioxime; acrylates or methacrylates such as ethylene dimethacrylate, polyethylene glycol dimethacrylate, trimethylolpropane trimethacrylate, cyclohexyl methacrylate, acrylic acid/zinc oxide mixture, and allyl methacrylate; vinyl monomers such as divinylbenzene, vinyltoluene, and vinylpyridine; allyl compounds such as hexamethylene diallyl nadimide, diallyl itaconate, diallyl phthalate, diallyl isophthalate, diallyl monoglycidyl isocyanurate, triallyl cyanurate, and triallyl isocyanurate; maleimide compounds such as N,N′-m-phenylene bismaleimide and N,N′-(4,4′-methylene diphenylene) dimaleimide; and cyclic non-conjugated dienes such as vinyl norbornene, ethylidene norbornene, and dicyclopentadiene. These crosslinking aids may be used alone or can be used in combination thereof.

It is possible to blend the crosslinked body (Q) according to the present embodiment with a heat resistant stabilizer, a weather stabilizer, an anti-static agent, a slip agent, an anti-blocking agent, an anti-fogging agent, a lubricant, a dye, a pigment, a natural oil, a synthetic oil, a wax, an organic or inorganic filler, and the like, as necessary, to an extent where the purpose of the present invention is not impaired, and a content thereof is an appropriate amount. Specific examples of the stabilizer blended as an optional component include phenol-based antioxidants such as tetrakis [methylene-3 (3, 5-di-t-butyl-4-hydroxyphenyl)propionate] methane, B-(3,5-di-t-butyl-4-hydroxyphenyl)propionic acid alkyl ester, and 2,2′-oxamidebis[ethyl-3 (3, 5-di-t-butyl-4-hydroxyphenyl) propionate]; fatty acid metal salts such as zinc stearate, calcium stearate, and calcium 12-hydroxystearate; and polyhydric alcohol fatty acid esters such as glycerin monostearate, glycerin monolaurate, glycerin distearate, pentaerythritol monostearate, pentaerythritol distearate, and pentaerythritol tristearate. These may be blended alone or in a combination thereof, and examples of the combination include a combination of tetrakis[methylene-3(3,5-di-t-butyl-4-hydroxyphenyl)propionate]methane with zinc stearate and glycerin monostearate.

A commercially available product of the thermal radical polymerization initiator include, for example, Irganox 1010, 1035, 1076, 1098, and 1135, manufactured by BASF Japan.

Examples of the organic or inorganic filler include silica, silica earth, alumina, titanium oxide, magnesium oxide, pumice powder, pumice balloon, aluminum hydroxide, magnesium hydroxide, basic magnesium carbonate, dolomite, calcium sulfate, potassium titanate, barium sulfate, calcium sulfite, talc, clay, mica, asbestos, glass fibers, glass flakes, glass beads, calcium silicate, montmorillonite, bentonite, graphite, aluminum powder, molybdenum sulfide, boron fibers, silicon carbide fibers, polyethylene fibers, polypropylene fibers, polyester fibers, and polyamide fibers.

In order to mix the crosslinked body (Q) with various additives, a method in which the cyclic olefin copolymer (m) and various additives are melt-blended using an extruder or the like, or a solution blending method in which the cyclic olefin copolymer (m) and various additives are dissolved and dispersed in a suitable solvent, for example, a saturated hydrocarbon such as heptane, hexane, decane, and cyclohexane; or an aromatic hydrocarbon such as toluene, benzene, and xylene can be adopted.

The crosslinking reaction can also be performed on a mixture of the cyclic olefin-based resin composition and a compound such as the above-mentioned radical polymerization initiator, sulfur, and hydrosilyl group-containing compound in a molten state; the crosslinking reaction can also be performed on the mixture in a solution state of being dissolved or dispersed in a solvent; or the crosslinking reaction can also be allowed to further proceed after volatilizing a solvent from a solution state where the mixture is dissolved in the solvent and molding the residue into any shape such as a film and a coating.

In a case where the reaction is performed in the molten state, a raw material mixture is melt-kneaded using a kneading device such as a mixing roll, a Banbury mixer, an extruder, a kneader, and a continuous mixer, and reacted. In addition, the crosslinking reaction can also be allowed to proceed after performing the molding by any method.

As a solvent to be used for performing the reaction in the solution state, the same solvent as the solvent used in the solution blending method.

In a case where the crosslinking reaction is performed using electron beams, the other radiation, or UV, the reaction can be performed after shaping by any method.

### Molded Body

The molded body according to the present embodiment includes the crosslinked body (Q) according to the present embodiment.

The molded body according to the present embodiment is, for example, a film or sheet.

Various known methods can be applied as a method for forming a film or sheet using the cyclic olefin copolymer (m) according to the present embodiment or the cyclic olefin-based resin composition according to the present embodiment. The method include, for example, a method in which the above-described varnish is applied onto a support base material such as a thermoplastic resin film to be dried, and then subjected to a heat treatment and the like to crosslink the cyclic olefin copolymer (m) according to the present embodiment or the cyclic olefin-based resin composition according to the present embodiment, thereby forming a film or sheet. A method for applying the varnish onto the support base material is not particularly limited, and examples thereof include coating using a spin coater, coating using a spray coater, and coating using a bar coater.

In addition, the method also include, for example, a method in which the cyclic olefin copolymer (m) according to the present embodiment or the cyclic olefin-based resin composition according to the present embodiment is melt-molded to obtain a film or sheet.

The film or sheet of the present embodiment can be used as a layered product for various purposes by being laminated over a base material. As a method for forming the layered product of the present embodiment, various known methods can be applied.

The layered product can be manufactured by, for example, laminating a film or sheet produced by the above-described method over a base material, and performing heating and curing by pressing and the like as necessary.

In addition, the layered product can also be manufactured by laminating an electrically insulating layer including the above-described crosslinked body over a conductor layer.

The cyclic olefin copolymer (m) according to the present embodiment or the cyclic olefin-based resin composition according to the present embodiment may be formed over surface layers of various multi-layer molded bodies or multi-layer laminated films. In this case, a resin layer formed from the cyclic olefin copolymer (m) according to the present embodiment or the cyclic olefin-based resin composition according to the present embodiment is preferably 100 μm or less.

The various multi-layer molded bodies or multi-layer laminated films include, for example, a multi-layer molded body for an optical lens, in which the cyclic olefin copolymer (m) according to the present embodiment or the cyclic olefin-based resin composition according to the present embodiment is formed over a surface of a resin optical lens, a multi-layer gas barrier film in which the cyclic olefin copolymer (m) according to the present embodiment or the cyclic olefin-based resin composition according to the present embodiment is formed over a surface of a resin film such as a PET film and a PE film in order to impart gas barrier properties.

In addition, the molded body according to the present embodiment may be, for example, a prepreg. The prepreg of the present embodiment is formed by combining the cyclic olefin copolymer (m) according to the present embodiment or the cyclic olefin-based resin composition according to the present embodiment with a sheet-like fiber base material.

A method for preparing the prepreg is not particularly limited, various known methods can be used. The method include, for example, a method including a step of impregnating the above-described varnish into a sheet-like fiber base material to obtain an impregnated body, and a step of heating the obtained impregnated body and drying the solvent included in the varnish.

The impregnation of the varnish into the sheet-like fiber base material can be performed by, for example, applying a predetermined amount of the varnish onto the sheet-like fiber base material by a known method such as spray coating, dip coating, roll coating, curtain coating, die coating, and slit coating, overlaying a protective film thereon as necessary, and performing pressing with a roller and the like thereon from the upper side.

In addition, the step of heating the impregnated body and drying the solvent included in the varnish is not particularly limited, and examples thereof include a method such as batchwise drying in air or nitrogen with a blower dryer, or drying by heating in a heating furnace in a continuous step.

In the present embodiment, the prepreg can be obtained by impregnating the varnish into the sheet-like fiber base material, and then heating an impregnated body thus obtained to a predetermined temperature to evaporate the solvent included in the varnish.

As fibers constituting the sheet-like fiber base material according to the present embodiment, inorganic and/or organic fibers can be used and the fibers are not particularly limited. The fibers include, for example, organic fibers such as polyethylene terephthalate (PET) fibers, aramid fibers, ultra-high molecular polyethylene fibers, polyamide (nylon) fibers, and liquid crystal polyester fibers; and inorganic fibers such as glass fibers, carbon fibers, alumina fibers, tungsten fibers, molybdenum fibers, titanium fibers, steel fibers, boron fibers, silicon carbide fibers, and silica fibers. Among these, the organic fibers or the glass fibers are preferable, and the aramid fibers, the liquid crystal polyester fibers, and the glass fibers are more preferable. Examples of the glass fibers include E glass, NE glass, S glass, D glass, H glass, and T glass.

The impregnation of the varnish into the sheet-like fiber base material is carried out by, for example, immersion and coating. The impregnation may be repeated a plurality of times, as necessary.

These sheet-like fiber base materials may be used or in combination of two or more kinds thereof. The amount of the sheet-like fiber base material to be used is appropriately selected according to demands, but is usually in a range of 10% to 90% by mass, preferably 20% to 80% by mass, and more preferably 30% to 70% by mass in the prepreg or layered product. Within these ranges, the dielectric characteristics and the mechanical strength of the obtained layered product are highly balanced, which is preferable.

A thickness of the prepreg according to the present embodiment is appropriately selected according to the purpose of use, but is usually 0.001 to 10 mm, preferably 0.005 to 1 mm, and more preferably 0.01 to 0.5 mm. Within these ranges, the shaping properties at the time of lamination and the characteristics such as mechanical strength and toughness of the layered product obtained by curing are sufficiently exhibited, which is suitable.

Since the cyclic olefin copolymer (m) according to the present embodiment or the cyclic olefin-based resin composition according to the present embodiment is excellent in dielectric characteristics, heat resistance, mechanical characteristics, and the like, it can be suitably used for a circuit board.

As a method for producing the circuit board, a generally known method can be used and the method is not particularly limited. The method include, for example, a film, a sheet, or a prepreg produced by the above-mentioned method is heated and cured by a lamination press or the like to form an electrically insulating layer. Next, a conductor layer is laminated over the obtained electrically insulating layer by a known method to manufacture a layered product. Thereafter, the conductor layer in the layered product or the like can be subjected to circuit processing and the like to obtain a circuit board.

As a metal for the conductor layer, metals such as copper, aluminum, nickel, gold, silver, and stainless steel can be used. A method for forming the conductor layer include, for example, a method in which a metal is formed into a foil or the like, and thermally fused onto the electrically insulating layer, a method in which a metal is formed into a foil or the like and bonded to an electrically insulating layer using an adhesive, a method in which a conductor layer formed of the metals is formed over an electrically insulating layer by a method of sputtering, vapor deposition, plating, or the like. In an aspect of the circuit board, either a single-sided board or a double-sided board may be used.

Such a circuit board can be used as an electronic device by, for example, mounting an electronic part such as a semiconductor element thereon. The electronic device can be manufactured, based on known information.

Such an electronic device include, for example, ICT infrastructure equipment such as a server, a router, a supercomputer, a mainframe, and a workstation; antennas such as a GPS antenna, antennas for a radio base station, a millimeter wave antenna, and an RFID antenna; communication devices such as a mobile phone, a smartphone, a PHS, a PDA, and a tablet terminal; digital devices such as a personal computer, a television, a digital camera, a digital video camera, a POS terminal, a wearable terminal, and a digital media player; vehicle-mounted electronic devices such as an electronic control system device, a vehicle-mounted communication device, a car navigation device, a millimeter wave radar, and an in-vehicle camera module; and semiconductor testing devices, high-frequency and measurement devices, and the like.

In addition, a foamed body can be obtained by crosslinking the cyclic olefin copolymer (m) according to the present embodiment or the cyclic olefin-based resin composition according to the present embodiment to be foamed. In this case, the above-mentioned foaming agent may be added to the cyclic olefin-based resin composition.

### Uses

Since the crosslinked body (Q) according to the present embodiment is excellent in solvent resistance, heat resistance, mechanical strength, and transparency, a molded body formed of the crosslinked body (Q) can be used in uses as, for example, an optical fiber, an optical waveguide, an optical disc substrate, an optical filter, a lens, an optical adhesive, a PDP optical filter, a coating material for an organic EL, a base film base material for a solar cell in an aerospace field, a coating material for a solar cell and a thermal control system, a semiconductor element, a light emitting diode, electronic elements such as various types of memory, a hybrid IC, an MCM, a circuit board, a prepreg or layered product used for forming an insulating layer of a circuit board, overcoat materials or interlayer insulating materials for a display component or the like, a substrate for a liquid crystal display or a solar cell, medical instruments, automobile members, a mold releasing agent, a resin modifier, a transparent substrate for a display, members for a lithium-ion battery, semiconductor process members, a film capacitor, a gas barrier coating material, an electric wire coating material, automobile members, aerospace members, a process material for a semiconductor, a wire coating material, members for a lithium-ion battery, members for a fuel cell, a capacitor film, flexible display members, an anchor coat material, a transparent adhesive, a modified material, a crosslinking aid, a medical container, medical catheter members, a waterproof sealing material, a releasing material, a hard coat material, or a foam modifier.

In particular, since the crosslinked body (Q) is excellent in temporal stability of the dielectric characteristics, and is also excellent in solvent resistance, heat resistance, transparency, mechanical characteristics, and the like, it can be suitably used in high-frequency uses such as a high-frequency circuit board. Furthermore, since the crosslinked body (Q) is also excellent in gas barrier properties, it can be suitably used as a substrate for a liquid crystal display, a substrate of a solar cell, or a film or sheet.

The embodiments of the present invention have been described above, but these are examples of the present invention and various configurations other than the examples can also be adopted.

In addition, the present invention is not limited to the above-mentioned embodiments, and modifications, improvements, and the like within the range in which the object of the present invention can be achieved are included in the present invention. Examples

Hereinafter, the present invention will be described in more detail with reference to Synthesis Examples and Examples, but the present invention is not limited thereto in any way.

Furthermore, the compositions of the cyclic olefin-based copolymer (m) used in Synthesis Examples, Examples, and Comparative Examples were measured by the methods described below.

### Method for Measuring Content of Each Structural Unit Constituting Cyclic Olefin-Based Copolymer

Determination of the contents of the structural units (A), the structural units (B), the structural units (C), and the structural units (D) was performed by measurement under the following conditions using a nuclear magnetic resonance device, “EXcalibur 270” manufactured by JEOL Ltd.
Integration times: 16 to 64 times
Measurement temperature: Room temperature

From a ¹H-NMR spectrum obtained by the measurement, a content of the structural units was calculated from the intensity of a peak derived from hydrogen directly bonded to the double-bonded carbon and the intensity of a peak of the other hydrogen.

In addition, the number-average molecular weight (Mn) of the cyclic olefin-based copolymer (m) used in Synthesis Examples, Examples, and Comparative Examples was measured by GPC measurement, and determined as a standard polystyrene-equivalent value. The GPC measurement was performed under the following conditions.
Device: GPC HLC-8321 (manufactured by Tosoh Corporation)
Solvent: o-Dichlorobenzene
Columns: TSKgel GMH6−HT×2, TSKgel GMH6−HTL×2 (both manufactured by Tosoh Corporation)
Flow rate: 1.0 ml/min
Sample: 1 mg/mL o-Dichlorobenzene solution
Temperature: 140° C.

The following raw materials were used for the experiment.

Transition metal compound (1):

The compound was synthesized by the method described in Japanese Unexamined Patent Publication No. 2004-331965.

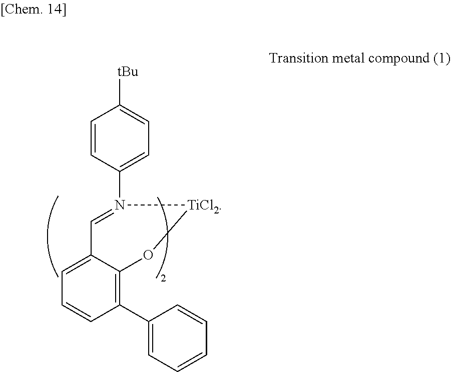

Ethylene (manufactured by Sumitomo Seika Chemicals Co., Ltd.)
Modified methylaluminoxane (MMAO, manufactured by Tosoh Finechem Co., Ltd.)
Toluene (manufactured by Wako Pure Chemical Industries, Ltd.: Wako Special Grade)
5-Vinyl-2-norbornene (manufactured by Tokyo Chemical Industry Co., Ltd.)
2-Norbornene (manufactured by Tokyo Chemical Industry Co., Ltd.)
Acetone (manufactured by Wako Pure Chemical Industries, Ltd.: Wako Special Grade)
Methanol (manufactured by Wako Pure Chemical Industries, Ltd.: Wako Special Grade)
Initiator 1: Percumyl D (manufactured by NOF Corporation)
Antioxidant 1: Irganox 1010 (manufactured by BASF SE)
Cyclic olefin-based copolymer (m):

### Synthesis Example 1: Cyclic Olefin-Based Copolymer (m1)

372 mL of toluene, 95 mL of 5-vinyl-2-norbornene (hereinafter also referred to as VNB), 33 mL of a 5 M toluene solution of 2-norbornene (hereinafter also referred to as NB), 1.5 mmol in terms of Al of a hexane solution of MMAO, and 1, 116mL of hydrogen were charged into an SUS-made autoclave having an internal volume of 1 L, which had been sufficiently nitrogen-substituted, and then ethylene was introduced into the system until the total pressure reached 0.78 MPaG. 4 μmol of the transition metal compound (1) dissolved in toluene was added thereto to initiate polymerization. After performing the reaction at 35° C. for 40 minutes, a step of adding 4 μmol of the transition metal compound (1) and further adding 4 μmol of the transition metal compound (1) every 30 minutes was repeated twice, and the polymerization was performed for a total of 130 minutes. Thereafter, a small amount of methanol was added to stop the polymerization. After the completion of the polymerization, ion exchange water was added to the obtained polymer solution, the mixture was stirred for 1 hour, and then the organic layer was filtered through filter paper. The organic layer was added to acetone to precipitate the polymer, which was stirred and filtered through filter paper. The obtained polymer was dried under reduced pressure at 80° C. for 10 hours to obtain an ethylene/NB/VNB copolymer. A composition ratio of the NB-derived structure and a composition ratio of the VNB-derived structure in the polymer determined from NMR were 13 mol % and 35 mol %, respectively, and a number-average molecular weight (Mn) of the polymer determined from GPC measurement was 11,000.

### Synthesis Example 2: Cyclic Olefin-Based Copolymer (m-2)

An ethylene/NB/VNB copolymer was obtained in the same manner as in Synthesis Example 1, except that 410 mL of toluene, 50 mL of VNB, and 40 mL of NB (5 M toluene solution) were used.

A composition ratio of the NB-derived structure and a composition ratio of the VNB-derived structure in the polymer determined by NMR were 21 mol % and 20 mol %, respectively, and a number-average molecular weight (Mn) of the polymer determined by the GPC measurement was 10,000.

### Synthesis Example 3: Cyclic Olefin-Based Copolymer (m-3)

An ethylene/NB/VNB copolymer was obtained in the same manner as in Synthesis Example 1, except that 433 mL of toluene, 15 mL of VNB, 52 mL of NB (5 M toluene solution), and 1488 mL of hydrogen were used. A composition ratio of the NB-derived structure and a composition ratio of the VNB-derived structure in the polymer determined by NMR were 33 mol % and 10 mol %, respectively, and a number-average molecular weight (Mn) of the polymer determined by the GPC measurement was 7,500.

### Synthesis Example 4: Cyclic Olefin-Based Copolymer (m-4)

An ethylene/NB/VNB copolymer was obtained in the same manner as in Synthesis Example 1, except that 444 mL of toluene, 7 mL of VNB, and 49 mL of NB (5 M toluene solution) were used. A composition ratio of the NB-derived structure and a composition ratio of the VNB-derived structure in the polymer determined by NMR were 37 mol % and 6 mol %, respectively, and a number-average molecular weight (Mn) of the polymer determined by the GPC measurement was 11,100.

### Synthesis Example 5: Cyclic Olefin-Based Copolymer (m-5)

An ethylene/NB/VNB copolymer was obtained in the same manner as in Synthesis Example 1, except that 460 mL of toluene, 16 mL of VNB, 55 mL of NB (5 M toluene solution), and 744 mL of hydrogen were used. A composition ratio of the NB-derived structure and a composition ratio of the VNB-derived structure in the polymer determined by NMR were 32 mol % and 9 mol %, respectively, and a number-average molecular weight (Mn) of the polymer determined by the GPC measurement was 20,000.

### Synthesis Example 6: Cyclic Olefin-Based Copolymer (m-6)

410 mL of toluene, 19 mL of VNB, 71 mL of tetracyclo[4.4.0.1^{2,5,} 1^{7,10}]-3-dodecene (hereinafter also referred to as TD), and 1.5 mmol in terms of Al of a toluene solution of MMAO (manufactured by Tosoh Finechem Corporation), and 744 mL of hydrogen were charged into an SUS-made autoclave having an internal volume of 1 L, which had been sufficiently nitrogen-substituted, and then ethylene was introduced into the system until the total pressure reached 0.78 MPa. 33 μmol of the transition metal compound (1) dissolved in toluene was added thereto, the mixture was polymerized at 35° C. for 180 minutes, and a small amount of methanol was added thereto to stop the polymerization. After the completion of the polymerization, ion exchange water was added to the obtained polymer solution, the mixture was stirred for 1 hour, and then the organic layer was filtered through filter paper. The organic layer was added to acetone to precipitate the polymer, which was stirred and filtered through filter paper. The obtained polymer was dried under reduced pressure at 80° C. for 10 hours to obtain an ethylene/TD/VNB copolymer. A composition ratio of the VNB-derived structure and a composition ratio of the TD-derived structure in the polymer determined by NMR were 30 mol % and 12 mol %, respectively, and the number-average molecular weight (Mn) of the polymer determined by GPC measurement was 11, 300.

### Synthesis Example 7: Cyclic Olefin-Based Copolymer (m-7)

An ethylene/TD/VNB copolymer was obtained in the same manner as in Synthesis Example 6, except that 377 mL of toluene, 73 mL of VNB, and 50 mL of TD were used. A composition ratio of the VNB-derived structure and a composition ratio of the TD-derived structure in the polymer determined by NMR were 15 mol % and 28 mol %, respectively, and the number-average molecular weight (Mn) of the polymer determined by GPC measurement was 10,500.

### Synthesis Example 8: Cyclic Olefin-Based Copolymer (m-8)

340 mL of toluene, 35 mL of VNB, 82 mL of NB (5 M toluene solution), 44 mL of TD, 2 mmol in terms of Al of a hexane solution of MMAO, and 558 mL of hydrogen were charged into an SUS-made autoclave having an internal volume of 1 L, which had been sufficiently substituted with nitrogen, and then ethylene was introduced into the system until the total pressure reached 0.52 MPaG. 4.7 μmol of the transition metal compound (1) dissolved in toluene was added thereto to initiate polymerization. The mixture was reacted at 35° C. for 40 minutes, 9.3 μmol of the transition metal compound (1) was added thereto, and after 30 minutes, 9.3 μmol of the transition metal compound (1) was further added thereto, and then the mixture was reacted for 30 minutes to perform polymerization for a total of 100 minutes. Thereafter, a small amount of methanol was added to stop the polymerization. After the completion of the polymerization, ion exchange water was added to the obtained polymer solution, the mixture was stirred for 1 hour, and then the organic layer was filtered through filter paper. The organic layer was added to acetone to precipitate the polymer, which was stirred and filtered through filter paper. The obtained polymer was dried under reduced pressure at 80° C. for 10 hours to obtain an ethylene/TD/NB/VNB copolymer. A composition ratio of the TD-derived structure, a composition ratio of the NB-derived structure, and a composition ratio of the VNB-derived structure in the polymer determined by NMR were 14 mol %, 17 mol %, and 10 mol %, respectively, and a number-average molecular weight (Mn) of the polymer determined by the GPC measurement was 8,400.

### Example 1

Each varnish was manufactured by the following method and evaluated.

(Preparation of 45% Toluene Varnish) 3.6 g of the cyclic olefin-based copolymer (m-1) obtained in Synthesis Example 1 was added to 4.4 g of toluene, and the mixture was stirred overnight to obtain a varnish-like cyclic olefin-based copolymer resin composition (45% toluene varnish).

(Solvent Solubility: Measurement of Varnish Viscosity) The 45% toluene varnish obtained as described above (Preparation of 45% Toluene Varnish) was subjected to a viscosity measurement. The viscosity was measured with an E-type viscometer and determined from a value at a rotation speed of 20% or the closest to 20% of a measurement torque after the preheating. The obtained results are shown in Table 1. The measurement was performed under the following conditions.

Device: TVE-25H (manufactured by Toki Sangyo Co., Ltd)
Measurement cone: 1°34×R24

Here, with regard to the impregnability of the 45% toluene varnish, a case where the viscosity of the 45% toluene varnish was equal to or more than 100 and less than 500 (mPa·s) was defined as “A”, a case where the viscosity of the 45% toluene varnish was equal to or more than 500 and less than 1,000 (mPa·s) was defined as “B”, a case where the viscosity of the 45% toluene varnish was 1,000 or more (mPa·s), and a case where undissolved matter was present were defined as “C”.

### (Preparation of 20% Toluene Varnish)

The cyclic olefin-based copolymer (m−1) obtained in Synthesis Example 1, Initiator 1 (Percumyl D manufactured by NOF

Corporation) as a radical polymerization (crosslinking) initiator, Antioxidant 1 (Irganox 1010 manufactured by BASF SE) as an antioxidant, and toluene as a solvent were used and each weighed according to the content shown in Table 1. The weighed sample was stirred until it was sufficiently dissolved, thereby obtaining a varnish-like cyclic olefin-based copolymer resin composition (20% toluene varnish). Furthermore, the unit of the content of each raw material in Table 1 is part by mass.

### (Film Formation)

The 20% toluene varnish obtained in (Preparation of 20% Toluene Varnish) described above in accordance with the content shown in Table 1 was applied onto a mold release-treated PET film in the longitudinal direction at a coating rate of 10 mm/sec, and then dried in a nitrogen stream blower dryer at 150° C. for 4 minutes. Two of the obtained films were overlaid, pressed to 3.5 MPa by vacuum pressing, heated from room temperature (25° C.) at a constant rate, and held at 180° C. for 120 minutes to obtain a laminated film.

### Dielectric Loss Tangent

The dielectric loss tangent at 10 GHz of the film obtained by the (Film Formation) described above was measured by a cylindrical cavity resonator method according to JIS R1641.

In this case, a dielectric loss tangent of less than 0.0010 was evaluated as “A” and a dielectric loss tangent of equal to or more than 0.0010 was evaluated as “B”. In addition, a case where the dielectric loss tangent was not measurable was indicated as “C”. The results are shown in Table 1.

### Examples 2 to 4 and Comparative Examples 1 to 4

A 20% toluene varnish, a 45% toluene varnish, and a film were each manufactured in the same manner as in Example 1, except that the content of each component was changed to the content shown in Table 1, and each subjected to evaluation. The obtained results are shown in Table 1.

In this case, in Comparative Examples 2 and 3, an undissolved cyclic olefin-based copolymer was generated during the manufacture of a 45% toluene varnish and the 45% toluene varnish was not obtained. Therefore, in Comparative Examples 2 and 3, it was impossible to measure the varnish viscosity using the 45% toluene varnish.

In addition, in Comparative Example 3, a varnish-like cyclic olefin-based copolymer composition (20% toluene varnish) was obtained, but in Comparative Example 2, the varnish-like cyclic olefin-based copolymer composition (20% toluene varnish) was not obtained.

From the above, in Comparative Example 2, the dielectric 10 loss tangent was not measurable, and therefore, the results of Comparative Example 2 in Table 1 are indicated as “Not measurable”.

TABLE 1

| | | | | | | | Number- | | | |
|---|---|---|---|---|---|---|---|---|---|---|
| | | | | | | TD + | average | | | |
| | | TD | NB | VNB | NB + | NB + | molecular | | | |
| | | content | content | content | VNB | VNB | weight | Example | Example | Example |
| | | (mol %) | (mol %) | (mol %) | (mol %) | (mol %) | Mn | 1 | 2 | 3 |
| Cyclic olefin- | (m-1) | 0 | 13 | 35 | 48 | 48 | 11,000 | 100 | | |
| based | (m-2) | 0 | 21 | 20 | 41 | 41 | 10,000 | | 100 | |
| copolymer | (m-3) | 0 | 33 | 10 | 43 | 43 | 7,500 | | | 100 |
| (m) | (m-4) | 0 | 37 | 6 | 43 | 43 | 11,100 | | | |
| | (m-5) | 0 | 32 | 9 | 41 | 41 | 20,000 | | | |
| | (m-6) | 30 | 0 | 12 | 12 | 42 | 11,300 | | | |
| | (m-7) | 15 | 0 | 28 | 28 | 43 | 10,500 | | | |
| | (m-8) | 14 | 17 | 10 | 27 | 41 | 8,400 | | | |

| | | | | |
|---|---|---|---|---|
| Radical | Initiator 1 | 2.1 | 2.1 | 2.1 |
| polymerization | | | | |
| initiator | | | | |
| Antioxidant | Antioxidant 1 | 0.06 | 0.06 | 0.06 |
| Solvent | Toluene | 400 | 400 | 400 |
| Solvent | Varnish viscosity (mPa · s) | 140 | 150 | 169 |
| solubility | 45% toluene varnish | | | |
| | Impregnability | A | A | A |
| Dielectric | Dielectric loss tangent | 0.0015 | 0.0008 | 0.0006 |
| loss tangent | 10 GHz | | | |
| 10 GHz | Evaluation | B | A | A |

| | Example | Comparative | Comparative | Comparative | Comparative |
|---|---|---|---|---|---|
| | 4 | Example 1 | Example 2 | Example 3 | Example 4 |
| Cyclic olefin- | | | | | |
| based | | | | | |
| copolymer | | | | | |
| (m) | 100 | | | | |
| | | 100 | | | |
| | | | 100 | | |
| | | | | 100 | |
| | | | | | 100 |
| Radical | 2.1 | 2.1 | 2.1 | 2.1 | 2.1 |
| polymerization | | | | | |
| initiator | | | | | |
| Antioxidant | 0.06 | 0.06 | 0.06 | 0.06 | 0.06 |
| Solvent | 400 | 400 | 400 | 400 | 400 |
| Solvent | 230 | >1,000 | Dissolution | Dissolution | >1,000 |
| solubility | | | NG | NG | |
| | A | C | C | C | C |
| Dielectric | 0.0005 | 0.0006 | Not | 0.0011 | 0.0012 |
| loss tangent | | | measurable | | |
| 10 GHz | A | A | C | B | B |

In Examples 1 to 4, it was possible to obtain a crosslinked body having excellent dielectric characteristics in a high-frequency region suitable for a circuit board and the like while maintaining a low viscosity even in a case of manufacturing the varnish in a state where a large amount of the cyclic olefin-based copolymer was included.

On the other hand, in Comparative Examples 1 to 4, in a case of manufacturing the varnish in a state where a large amount of the cyclic olefin-based copolymer was included, the results were that the cyclic olefin-based copolymer was not completely dissolved, or that even in a case where the cyclic olefin-based copolymer was dissolved, the viscosity was high, leading to a deterioration in the impregnability.

This application claims priority based on Japanese Patent Application No. 2022-016604 filed on Feb. 4, 2022, the disclosures of which are incorporated herein by reference in their entireties.

1. A cyclic olefin-based copolymer comprising:
(A) structural units (A) derived from one or more olefins represented by General Formula (I);
(B) structural units (B) derived from one or more cyclic non-conjugated dienes represented by General Formula (II); and
(C) structural units (C) derived from one or more cyclic olefins represented by General Formula (III),
wherein a total of a content of the structural units (B) derived from the cyclic non-conjugated dienes and a content of the structural units (C) derived from the cyclic olefins is in a range of equal to or more than 40.0 mol % and equal to or less than 50.0 mol % in a case where a total molar amount of the structural units (A), the structural units (B), and the structural units (C) in the cyclic olefin-based copolymer is set to 100 mol %, and
a number-average molecular weight Mn of the cyclic olefin-based copolymer is equal to or more than 3,000 and equal to or less than 16,000, 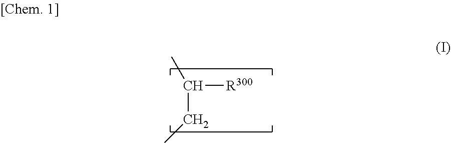
in General Formula (I), R³⁰⁰ represents a hydrogen atom or a linear or branched hydrocarbon group having 1 to 29 carbon atoms 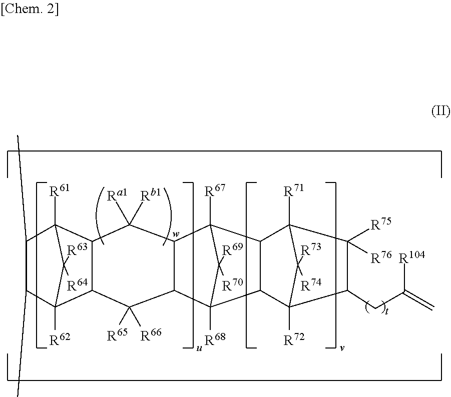
in General Formula (II), u is 0 or 1, v is 0 or 1, w is 0 or 1, R⁶¹ to R⁷⁶ and R^{a1} and R^{b1} may be the same as or different from each other and are a hydrogen atom, a halogen atom, an alkyl group having 1 to 20 carbon atoms, a halogenated alkyl group having 1 to 20 carbon atoms, a cycloalkyl group having 3 to 15 carbon atoms, or an aromatic hydrocarbon group having 6 to 20 carbon atoms, R¹⁰⁴ is a hydrogen atom or an alkyl group having 1 to 10 carbon atoms, t is a positive integer of 0 to 10, and R⁷⁵ and R⁷⁶ may be bonded to each other to form a monocyclic ring or a polycyclic ring 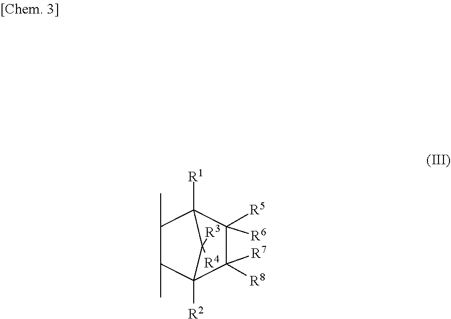
in General Formula (III), R¹ to R⁸ are each independently a hydrogen atom, a halogen atom, or a hydrocarbon group having 4 or less carbon atoms, R⁵ to R⁸ may be bonded to each other to form a monocyclic ring, the monocyclic ring may have a double bond, and an alkylidene group may be formed between R⁵ and R⁶ or between R⁷ and R⁸.

2. The cyclic olefin-based copolymer according to claim 1, wherein in a case where the total molar amount of the structural units (A), the structural units (B), and the structural units (C) in the cyclic olefin-based copolymer is set to 100 mol %, the content of the structural units (B) derived from the cyclic non-conjugated dienes is equal to or more than 5 mol % and equal to or less than 40 mol %.

3. The cyclic olefin-based copolymer according to claim 1,
wherein the cyclic non-conjugated diene constituting the structural units (B) derived from the cyclic non-conjugated dienes includes 5-vinyl-2-norbornene.

4. The cyclic olefin-based copolymer according to any one of claim 1,
wherein the cyclic olefin constituting the structural units (C) derived from the cyclic olefins includes bicyclo[2.2.1]-2-heptene.

5. A cyclic olefin-based copolymer composition comprising:
the cyclic olefin-based copolymer according to claim 1.

6. A varnish comprising:
cyclic olefin-based copolymer composition according to claim 5; and
a solvent.

7. A crosslinked body obtained by crosslinking the cyclic olefin-based copolymer composition according to claim 5.

8. A film or sheet comprising:
the crosslinked body according to claim 7.

9. A layered product comprising:
the crosslinked body according to claim 7.

10. A circuit board comprising:
an electrically insulating layer including the crosslinked body according to claim 7; and
a conductor layer provided over the electrically insulating layer.

11. An electronic device comprising:
the circuit board according to claim 10.

12. A prepreg comprising:
cyclic olefin-based copolymer according to claim 1; and
a sheet-like fiber base material.
